(19) United States
(12) Patent Application Publication
(10) Pub. No.: US 2014/0215230 A1
(43) Pub. Date: Jul. 31, 2014

(54) POWER ADAPTER DEVICE AND MAIN COMPUTER SYSTEM THEREOF

(71) Applicant: AOPEN INC., New Taipei City (TW)

(72) Inventor: TING-YU CHANG, New Taipei City (TW)

(73) Assignee: AOPEN INC., New Taipei City (TW)

(21) Appl. No.: 14/080,015

(22) Filed: Nov. 14, 2013

(30) Foreign Application Priority Data
Jan. 29, 2013 (TW) 102201917

(51) Int. Cl. G06F 1/26; H02J 4/00

(52) U.S. Cl. CPC G06F 1/266; H02J 4/00
USPC 713/300; 307/39

(57) ABSTRACT

The present invention discloses a power adapter device and a main computer system thereof. The power adapter device is provided for receiving a power signal from a power supply device and providing the power signal to an electric apparatus and an additional apparatus. The power adapter device comprises a power connection port, a first connection port, a second connection port, a current detecting module and a switch module. The power connection port is provided for receiving the power signal. When the electric apparatus receives the power signal via the first connection port, the current detecting module detects a current signal and generates a control signal according to the current signal. When the current detecting module generates the control signal, the switch module is turned on so as to transmit the power signal to the additional apparatus through the second connection port.

### BACKGROUND OF THE INVENTION

1. Field of the Invention

The exemplary embodiment(s) of the present invention relates to a power adapter device and a main computer system thereof. More specifically, the exemplary embodiment(s) of the present invention relates to a power adapter device and a main computer system thereof which can decide to output the power signal according to the connection of the electronic apparatus.

2. Description of the Related Art

With the advance of science and technology, the applications of the computer system nowadays are wider and wider. Several simple and small electronic apparatuses developed recently have been treated as a small computer host. Moreover, because the functions of these small electronic apparatuses are powerful, an electronic board or a server are developed and structured nowadays by integrating these small electronic apparatuses. These small electronic apparatuses usually connect to an adapter to receive the power signal and thus operate, and it is no need to install conventional power supply device, e.g. advanced technology extended (ATX) power supply device. However in the prior arts, if the plurality of small electronic apparatuses is integrated, the number of the adapters would be large and complicated. Besides, the adapter could only provide single kind of power signal to single electronic apparatus, but could not provide extra power and could not provide power to the plurality of electronic apparatuses. Instead, the conventional power supply device would be able to provide different power signal to different electronic apparatus. In addition, when the adapter is disposed on, the power would be provided continuously, thereby consuming the power source. However, the conventional power supply device could provide the power after receiving the turning-on signal, and thus it could efficiently save the power.

Therefore, a power adapter device and a main computer system thereof which could cooperate the electronic apparatus with the power supply device have to be invented so as to solve the problem of the prior arts.

### SUMMARY OF THE INVENTION

It is a main object of the present invention is to provide a power adapter device which has a function of deciding the output power signal according to the connection of the electronic apparatus.

It is another main object of the present invention is to provide a main computer system having the above-mentioned power adapter device.

In order to achieve the above objects, the power adapter device of the present invention is used for receiving the power signal from the power supply device and providing the power signal to the electric apparatus and the additional apparatus. The power adapter device comprises a power connection port, a first connection port, a second connection port, a current detecting module, and a switch module. The power connection port is connected to the power supply device for receiving the power signal. The first connection port is connected to the electric apparatus. The second connection port is connected to the additional apparatus. The current detecting module is electrically coupled with and disposed between the power connection port and the first connection port, when the electric apparatus receives the power signal via the first connection port, the current detecting module detects a current signal and generates a control signal according to the current signal. The switch module is electrically coupled with the current detecting module, and is disposed between the power connection port and the second connection port, wherein when the current detecting module generates the control signal, the switch module is turned on so as to transmit the power signal to the additional apparatus through the second connection port.

The main computer system of the present invention comprises a power supply device, an electric apparatus, an additional apparatus, and a power adapter device.

The power supply device is used for providing a power signal. The power adapter device is electrically coupled with the power supply device, the electric apparatus, and the additional apparatus for receiving the power signal from the power supply device and providing the power signal to the electric apparatus and the additional apparatus. The power adapter device comprises a power connection port, a first connection port, a second connection port, a current detecting module and a switch module. The power connection port is connected to the power supply device for receiving the power signal. The first connection port is connected to the electric apparatus. The second connection port is connected to the additional apparatus. The current detecting module is electrically coupled with and disposed between the power connection port and the first connection port, when the electric apparatus receives the power signal via the first connection port, the current detecting module detects a current signal and generates a control signal according to the current signal. The switch module is electrically coupled with the current detecting module, and disposed between the power connection port and the second connection port, wherein when the current detecting module generates the control signal, the switch module is turned on so as to transmit the power signal to the additional apparatus through the second connection port.

Another main computer system of the present invention comprises a power supply device, a plurality of electric apparatuses, a plurality of additional apparatuses and a power adapter device. The power supply device provides a power signal. The power adapter device is electrically coupled with the power supply device, the plurality of electric apparatuses, and the plurality of additional apparatuses for receiving the power signal from the power supply device and providing the power signal to the plurality, of electric apparatuses and the plurality of additional apparatuses. The power adapter device comprises a power connection port, a plurality of first connection ports, a plurality of second connection ports, a current detecting module, and a switch module. The power connection port is connected to the power supply device and provided for receiving the power signal. The plurality of first connection ports is connected to the plurality of electric apparatuses, and the plurality of second connection ports is connected to the plurality of additional apparatuses. The current detecting module is electrically coupled with and disposed between the power connection port and the plurality of first connection ports, when any one of the plurality of electric apparatuses receives the power signal via any one of the plurality of first connection ports, the current detecting module detects a current signal and generates a control signal according to the current signal. The switch module is electrically coupled with the current detecting module, and disposed between the power connection port and the plurality of second connection ports, wherein when the current detecting module generates the control signal, the switch module is turned on so as to transmit the power signal to the plurality of additional apparatuses through the plurality of second connection ports.

The structure of the present invention is novel, could be broadly used in the industry and does improve the effect, and thus is applied for being patented.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a structural schematic diagram of the first embodiment of the main computer system of the present invention.

FIG. 2 is a structural schematic diagram of the second embodiment of the main computer system of the present invention.

### DETAILED DESCRIPTION OF THE PREFERRED EMBODIMENTS

For facilitating understanding and clarifying the object, characteristics and advantages of the present invention, following specific embodiments and figures of the present invention are presented to make a detail description.

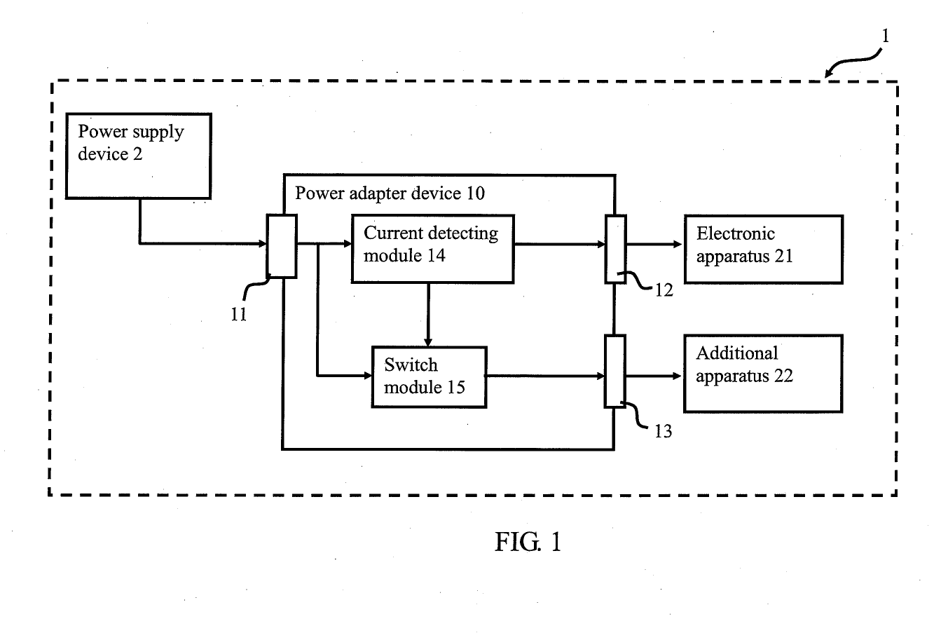

Following please refer to FIG. 1, which is a structural schematic diagram of the first embodiment of the main computer system of the present invention.

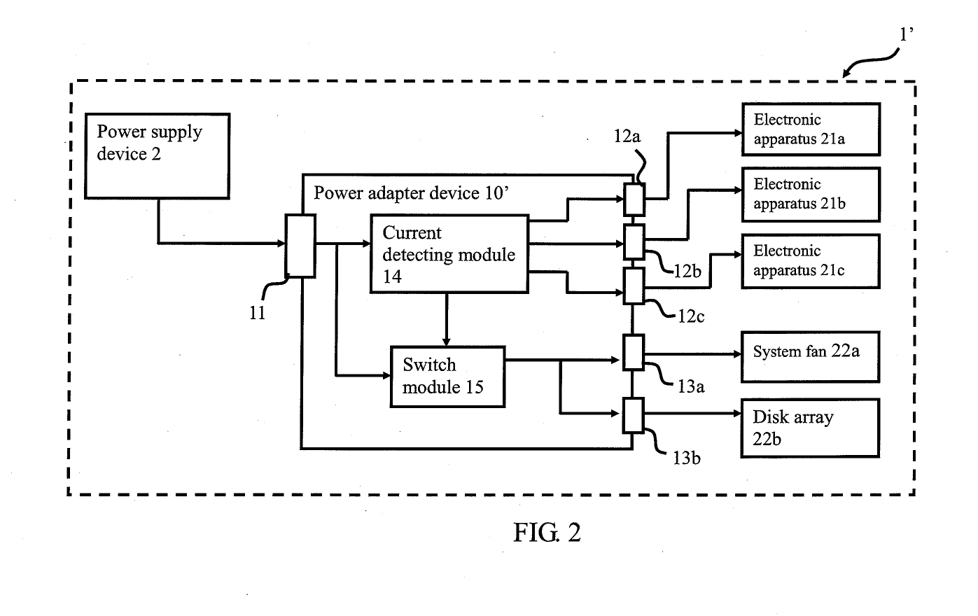

In the first embodiment of the present invention, the main computer system 1 comprises a power supply device 2, an electric apparatus 21, an additional apparatus 22, and a power adapter device 10. The specification of the power supply device 2 could be advanced technology extended (ATX), but the present invention is not limited within it. The power supply device 2 is used for providing a power signal. The voltage of the power signal could be 3.3 volt, 5 volt, or 12 volt; it could be adjusted according to different demands. The electric apparatus 21 could be an apparatus having a computing function such as a small computer host. The electric apparatus 21 has to receive the power signal and thus could operate. The additional apparatus 22 could be a system fan 22a or a disarray 22b (as shown in FIG. 2), which are apparatuses operate after receiving the power signal. The present invention is not limited within the apparatuses as above-listed.

The power adapter device 10 is electrically coupled with the power supply device 2, the plurality of electric apparatuses 21, and the additional apparatus 22, so as to transmit the power signal provided by the power supply device 2 to the electric apparatuses 21 and the additional apparatus 22. The power adapter device 10 comprises a power connection port 11, a first connection port 12, a second connection port 13, a current detecting module 14, and a switch module 15. The power connection port 11 is connected to the power supply device 2 for receiving the power signal generated by the power supply device 2. The pin number of the power connection port 11 is matched with the specification of the power supply device 2, such as 24 pins, but the present invention is not limited within it. The first connection port 12 is connected to the electric apparatus 21, and thus the electric apparatus 21 could receive the power signal through the first connection port 12. The second connection port 13 is connected to the additional apparatus 22, and similarly the additional apparatus 22 could receive the power signal through the second connection port 13. The current detecting module 14 could be a Hall-effect sensing module, but the present invention is not limited within it, the current detecting module 14 could also achieve the object of current detecting by other circuit or device. The current detecting module 14 is electrically coupled with and disposed between the power connection port 11 and the first connection port 12, and therefore when the electric apparatus 21 starts to receive the power signal via the first connection port 12, the power signal would flow through the current detecting module 14. Thus, the current detecting module 14 would sense a current signal due to the power signal flowing through therein, and the current detecting module 14 would then further generate a control signal to the switch module 15. The current detecting module 14 could generate the control signal when the current signal is detected over than 0.5 ampere, and thus it avoids disturbing the current detecting module 14 by the tiny current inside the apparatus.

The switch module 15 could be a module having a switching function such as a metal-oxide-semiconductor field-effect transistor (MOSFET) or a bipolar junction transistor (BJT), however the present invention is not limited within these examples. The switch module 15 is electrically coupled with the current detecting module 14, and disposed between the power connection port 11 and the second connection port 13. When the switch module 15 receives the control signal from the current detecting module 14, the switch module 15 is thus turned on and thereby making the power signal could be transmitted to the additional apparatus 22 through the second connection port 13, and the additional apparatus 22 thus could operate.

Next please refer to FIG. 2, which is a structural schematic diagram of the second embodiment of the main computer system of the present invention.

The present invention is not limited to provide only to single electric apparatus 21 or single additional apparatus. In the second embodiment of present invention, the main computer system 1′ could comprise a plurality of electric apparatuses 21a, 21b, 21c and a plurality of additional apparatuses 22, such as a system fan 22a and a disk array 22b. The plurality of electric apparatuses 21a, 21b, 21c could be same apparatuses or different apparatuses, and the number of the system fan 22a and the disk array 22b is not limited to one.

At the same time, the power adapter device 10′ may also comprise a plurality of first connection ports 12a, 12b, 12c and a plurality of second connection ports 13a and 13b, so the plurality of first connection ports 12a, 12b and 12c are connected to the plurality of electric apparatuses 21a, 21b and 21c respectively. The plurality of second connection ports 13a, 13b and 13c are connected to the system fan 22a and the disk array 22b respectively. When any one of the plurality of electric apparatuses 12a, 12b or 12c starts to receive the power signal via any one of the plurality of first connection ports 12a, 12b or 12c, the current detecting module 14 would also detect a current signal and thus generate a control signal. Therefore, the switch module would be turned on according to the control signal, and the power signal could be thus transmitted to the system fan 22a and the disk array 22b through the plurality of second connection ports 13a and 13b.

By above-mentioned power adapters device 10 or 10′, the present invention could effectively provide the power signal to single electric apparatus 21 or plurality of electric apparatuses 21a, 21b and 21c, and it could let the additional apparatus 22 receive the power signal after the electric apparatus 21 starts to operate, so as to decrease the power consumption.

In summary, regardless of the function, way and result of the present invention are shown different technical characteristics to prior arts, and it is a great break. Examiners would be appreciated to allow this patent after realizing the content of the present invention so as to benefit the society. However, the aforementioned embodiments are just for illustrating the principle and the result of the present invention, but not for limiting the range of the present invention. It will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A power adapter device, for receiving a power signal from a power supply device and providing the power signal to an electric apparatus and an additional apparatus, the power adapter device comprising:
a power connection port, connected to the power supply device for receiving the power signal;
a first connection port, connected to the electric apparatus;
a second connection port, connected to the additional apparatus;
a current detecting module, electrically coupled with and disposed between the power connection port and the first connection port, when the electric apparatus receives the power signal via the first connection port, the current detecting module detects a current signal and generates a control signal according to the current signal; and
a switch module, electrically coupled with the current detecting module, and disposed between the power connection port and the second connection port, wherein when the current detecting module generates the control signal, the switch module is turned on so as to transmit the power signal to the additional apparatus through the second connection port.

2. The power adapter device as claimed in claim 1, wherein the current detecting module is a Hall-effect sensing module.

3. The power adapter device as claimed in claim 1, wherein the current detecting module generates the control signal when the current signal is detected over than 0.5 ampere.

4. A main computer system, comprising:
a power supply device, providing a power signal;
an electric apparatus;
an additional apparatus;
a power adapter device, electrically coupled with the power supply device, the electric apparatus and the additional apparatus, for receiving the power signal from the power supply device and providing the power signal to the electric apparatus and the additional apparatus, the power adapter device comprising:
a power connection port, connected to the power supply device for receiving the power signal;
a first connection port, connected to the electric apparatus;
a second connection port, connected to the additional apparatus;
a current detecting module, electrically coupled with and disposed between the power connection port and the first connection port, when the electric apparatus receives the power signal via the first connection port, the current detecting module detects a current signal and generates a control signal according to the current signal; and
a switch module, electrically coupled with the current detecting module, and disposed between the power connection port and the second connection port, wherein when the current detecting module generates the control signal, the switch module is turned on so as to transmit the power signal to the additional apparatus through the second connection port.

5. The main computer system as claimed in claim 4, wherein the additional apparatus is a system fan.

6. The main computer system as claimed in claim 4, wherein the additional apparatus is a disk array.

7. The main computer system as claimed in claim 4, wherein the current detecting module is a Hall-effect sensing module.

8. The main computer system as claimed in claim 4, wherein the current detecting module generates the control signal when the current signal is detected over than 0.5 ampere.

9. A main computer system, comprising:
a power supply device, providing a power signal;
a plurality of electric apparatuses;
a plurality of additional apparatuses;
a power adapter device, electrically coupled with the power supply device, the plurality of electric apparatuses and the plurality of additional apparatuses, for receiving the power signal from the power supply device and providing the power signal to the plurality of electric apparatuses and the plurality of additional apparatuses, the power adapter device comprising:
a power connection port, connected to the power supply device for receiving the power signal;
a plurality of first connection ports, connected respectively to the plurality of electric apparatuses;
a plurality of second connection ports, connected respectively to the plurality of additional apparatuses;
a current detecting module, electrically coupled with and disposed between the power connection port and the plurality of first connection ports, when any one of the plurality of electric apparatuses receives the power signal via any one of the plurality of first connection ports, the current detecting module detects a current signal and generates a control signal according to the current signal; and
a switch module, electrically coupled with the current detecting module, and disposed between the power connection port and the plurality of second connection ports, wherein when the current detecting module generates the control signal, the switch module is turned on so as to transmit the power signal to the plurality of additional apparatuses through the plurality of second connection ports.

10. The main computer system as claimed in claim 9, wherein the additional apparatus comprises a system fan and a disk array.

11. The main computer system as claimed in claim 9, wherein the current detecting module is a Hall-effect sensing module.

12. The main computer system as claimed in claim 9, wherein the current detecting module generates the control signal when the current signal is detected over than 0.5 ampere.
